(19) United States
(12) Patent Application Publication
(10) Pub. No.: US 2016/0170562 A1
(43) Pub. Date: Jun. 16, 2016

(54) LIGHT GUIDE ASSEMBLY FOR OPTICAL TOUCH SENSING, AND METHOD FOR DETECTING A TOUCH

(71) Applicant: MULTI TOUCH OY, Helsinki (FI)

(72) Inventors: Tommi ILMONEN, Espoo (FI); Pekka ÄYRÄS, Helsinki (FI); Heikki HHYVÄRINEN, Kuopio (FI); Marco VÄLIMÄKI, Tuusula (FI)

(21) Appl. No.: 14/904,329

(22) PCT Filed: Jul. 14, 2014
(86) PCT No.: PCT/FI2014/050575

§ 371 Date: Jan. 11, 2016

(30) Foreign Application Priority Data
Jul. 12, 2013 (FI) PCT/FI2013/050762

(51) Int. Cl. G06F 3/042; F21V 8/00; G02B 6/35

(52) U.S. Cl. CPC G06F 3/0421; G02B 6/3522; G02B 6/005

(57) ABSTRACT

A light guide assembly (2) for use in a touch sensitive area (3) of an optical touch sensing device (1) for touch screens is configured to receive light, to allow the light thereby received to propagate in the light guide assembly, and to deliver the light thereby propagated in the light guide assembly further out of the light guide assembly. The light guide assembly comprises a plurality of light guide stripes (4, 4′ 5) for controlling the light propagation, and an interaction arrangement (27; 17; 21) configured to define at least one restricted interaction area (11) within the touch sensitive area for interaction between the light and the external object. The optical touch sensing device is configured to detect the presence of an external object (10) on the basis of changes in the light delivered further out of the light guide assembly due to interaction of the light with the external object. According to the invention, the light guide assembly comprises source-to-detector lines (4, 4′, 5) for at least two sources (31) and detectors (41), the source-to-detector lines being formed by light guide stripes (4), each of which is divided into at least two substripes (4′), one for each detector, each source-to-detector line having one interaction arrangement (27) defining a restricted interaction area (11).

### FIELD

The present invention relates to touch sensing devices for touch screens, in particular to optical touch sensing devices, more particularly to optical touch sensing devices relying on interaction of light propagating in/via a light guide assembly with an external touching object.

### BACKGROUND

User interfaces for different kinds of electrical apparatuses are nowadays more and more often realized by means of different types of touch screens, wherein a touch sensing device is superposed on or integrated in a display. In touch sensing devices, the user input is given by touching the touch sensitive area of the touch sensing device instead of operating conventional mechanical buttons, sliding bars, rollers, etc.

Conventionally, such touch sensing devices have been configured to rely on purely electronic operation. Most commonly, touch sensing devices are based on resistive or capacitive touch sensitive films, wherein a touch by a finger or some other pointer changes the resistivity of, or signal coupling between conductive elements of a sensitive film.

In various applications, however, optical touch sensing devices are preferred nowadays. In an optical touch sensing device, touches cause changes in optical signals or signal paths, instead of electric ones. In one known approach, a frame can be assembled over a display, the frame comprising one or more light sources producing a “light field” in the free air above the surface of the display. A touch disturbs this light field, which is detected by means of one or more cameras or light sensors located within the frame.

Instead of a light field in the free space, light can also be transmitted to propagate, e.g. via total internal reflections (TIR), in a planar light guide plate formed as a part of a touch screen. Typically, a plurality of light source elements are located at the periphery of the light guide plate, thus outside the actual touch sensitive center area of the light guide plate. The light propagating in the light guide plate interacts with the touching object in that a touch on the light guide plate changes the difference in the refractive indices between the light guide and the ambient, thereby changing the conditions for TIR, resulting in “leakage” of light energy out of the light guide. The decrease in the light intensity propagated through and finally received from the light guide is detected as an indication of a touch. Commercial products based on such “Frustrated Total Internal Reflection” (FTIR) are provided e.g. by FlatFrog Laboratories AB.

Instead of FTIR, the primary touch-sensitive mechanism used for touch detection can also be based on in-coupling of illumination light, initially coupled out of the light guide, back into the light guide as a result of reflection from a fingertip or some other pointer brought into sufficiently close proximity to the light guide. Thus, in this case, the interaction mechanism is reflection of the light from an external touching object. This approach is utilized e.g. in the solution disclosed in US 2010/0321339 A1. Various coupling elements can be used to implement said out-/in-coupling.

However, the prior art use of light guide plates has some challenges/limitations. For example, sufficient spatial resolution requires careful controlling of the propagation of light to/from specific locations of the touch sensitive area. This may require, for example, lenses or other optical means for controlling the directivity of the light emitting/receiving elements. Alternatively, or in addition to that, complex detection algorithms may be required.

As an alternative to solutions relying on interaction of the light with an external touching object such as a finger, some optical touch sensing devices have been reported wherein the touch detection is based on physical deformation of the structures wherein the light is transmitted to propagate in result of a touch. Said physical deformation makes part of the light energy to leak out of the intended path, so that the decrease in the received light energy can be considered as an indication of a touch. For example, an optical waveguide comprising a plurality of cores wherein the propagating light waves are limited to is disclosed in US 2010/0156848 A1. Deformation of the waveguide cores in response to a touch makes part of the light energy leak out of the waveguide cores. This kind of approach requires the overall structure of the touch sensing device to have carefully adjusted flexibility for allowing the required deformations.

To summarize, there is still need for further improved optical touch sensing devices.

### PURPOSE OF THE INVENTION

It is a purpose of the present invention to provide novel solutions for optical touch sensing devices where touch detection is based on interaction of light propagating in a light guide assembly with an external touching object.

### SUMMARY

The present invention is characterized by what is presented in claims 1, 8, 16, and 17.

According to a first aspect, the present invention is focused on a light guide assembly which can be used in a touch sensitive area of an optical touch sensing device for touch screens. A touch sensitive area of an optical touch sensing device means here the actual area on the touch detecting device surface, within which area the touches are to be detected. In this context, the concept of a “touch” has to be understood broadly to cover not only true touches with physical contact with the touch sensitive area but also the presence of an external “touching” object in a sufficiently close proximity to the touch sensitive area. By a touch screen is meant a touch-based user interface configuration comprising a display and a touch sensing device superposed on the display.

The light guide assembly is configured to, i.e. it is arranged and structured so that it is able to receive light, to allow the light thereby received to propagate in the light guide assembly, and to deliver the light thereby propagated in the light guide assembly further out of the light guide assembly.

The light guide assembly is configured for use in an optical touch sensing device which is configured to detect the presence of an external object on the basis of changes in the light delivered further out of the light guide assembly due to interaction of the light with the external object. Thus, the basic operation principle of such touch sensing device is based on interaction of the light propagating via the light guide assembly with an external object. Typically, the interaction changes, i.e. increases or decreases, the energy or intensity of the light delivered further out of the light guide assembly. The interaction of light with the external object distinguishes the present invention e.g. from those devices where the touch detection is based on physical deformation of some light guiding structure.

The “external object” can be, for example, a finger of the user of the touch sensing device or a touch screen, a part of which the touch sensing device forms. It can also be some other pointer with specific optical properties, e.g. with some specific predetermined reflection performance.

Naturally, an entire, operable optical touch sensing device shall have also other parts and elements, such as illuminating sources, e.g. light emitting diodes LEDs or laser diodes to generate the light to be received in the light guide assembly. Similarly, some means, e.g. photodiodes, are needed for sensing the light delivered further out of the light guide assembly. Finally, those sources and sensing means shall be powered and controlled. However, many of the core principles of the present invention relate to the light guide assembly, so this part of a complete touch sensing device is discussed in most detail in this document.

The light guide assembly comprises a plurality of light guide stripes for controlling the light propagation in the light guide assembly. In other words, instead of, or in addition to a possible single, uniform light guide plate, the light guide assembly to be located in the touch sensitive area of a touch sensing device comprises a plurality of separate light guide stripes for controlling the light propagation in the light guide assembly. By using a plurality of discrete light guide stripes, the propagation of light in the light guide assembly can be efficiently and accurately controlled. This opens great new possibilities for designing and manufacturing optical touch sensing devices. For example, more accurate spatial control of light propagation in the light guide assembly may allow use of simpler driving scheme of the illumination sources and/or simpler detection algorithms than in the case of only one continuous and uniform light guide plate. In general, using a plurality of light guide stripes, light can be transmitted from sources to detectors along accurate paths determined by the light guide stripes paths.

In this document, a “light guide” refers to any light guiding structure configured to guide light within a restricted volume. Typical examples are single-mode and multi-mode optical fibers and waveguides/light guides. For example, a light guide stripe can be implemented as a narrow stripe of a material with a higher refractive index, surrounded by a cladding formed of another material with a lower refractive index. The propagation can be based e.g. on total internal reflections (TIR). Then, with sufficiently high incident angle of the light rays with respect to the surface normal of the stripe, the light experiences a total internal reflection at the interface between the two materials. Thus, the light continues propagation within the stripe instead of escaping it. The light guide materials and other details can be designed according to the principles known in the art; therefore no detailed explanation on them is given in this document.

On the other hand, “interaction” of light with an external object refers to any kind of physical interaction between the light field and the external object, including, for example, reflection, refraction, and scattering at the surface of the object; transmission to and absorption in the object, and so on. As considered from the electromagnetic wave motion point of view, interaction covers all kinds mechanisms via which the external object in touch with or in proximity of the touch sensitive area directly affects the electromagnetic wave propagation.

The light guide assembly comprises an interaction arrangement configured to define at least one restricted interaction area within the touch sensitive area for interaction between the light and the external object. By restricted interaction area is meant that outside this area a touch of, or the presence in a close proximity of an external object such as a finger does not substantially interact with the light, and thus does not substantially change the light finally delivered out of the light guide assembly. Thus, in this embodiment, the spatial controllability of touch detection is further improved by the restricted interaction area. There can be a plurality of restricted interaction areas within the touch sensitive area. There can also be a plurality of interaction arrangements, each defining one or more restricted interaction areas.

According to the present invention, the light guide assembly comprises source-to-detector lines for at least two sources and detectors, the source-to-detector lines being formed by light guide stripes, each of which is divided into at least two sub-stripes, one for each detector of the at least two detectors, each source-to-detector line having one interaction arrangement defining a restricted interaction area.

In other words, the light guide stripe from each source of the at least two sources, i.e. the light guide stripe for receiving light from each single light source element of the touch sensing device, is divided into at least two sub-stripes. When in use, the light signal transmitted into such light guide stripe is thus divided between those sub-stripes, from which sub-stripes those partial signals are then finally delivered to the detectors. At the detector end of the source-to-detector lines, the sub-stripes originating from several different light guide stripes from different sources may be joined to form a common single light guide stripe guiding light signals from different sources to one single detector.

By “source-to-detector line” is thus meant here simply a light propagation path from a light source to a light detector, determined by a light guide stripe/sub-stripe.

The interaction arrangements lie preferably along the sub-stripe portions of the source-to-detector lines.

By means of the source-to-detector lines formed by the light guide stripes divided into several sub-stripes, the number of required light source and detector elements can be reduced. In addition to savings in component costs, this enables also a more compact assembly of the touch sensing device. Moreover, less dense packing of the light guide stripes is enabled, which allows for wider light guides stripes to be used, which can be beneficial to manufacturability and performance of the system.

The restricted interaction area can be defined by various structural means, depending also on the actual interaction mechanism for which the light guide assembly is configured. In one approach, the interaction arrangement comprises a two-way coupling arrangement configured to couple light out of the light guide assembly, out of one sub- stripe, and to couple a portion of the thereby out-coupled light, after reflection from the external object, back to the light guide assembly into the same sub-stripe for detecting the presence of the external object on the basis of said reflection. By detecting the light finally delivered out of this source-to-detector line, the presence of an external object within the restricted interaction area can be detected on the basis of increase in the light power delivered out the light guide assembly.

In the above approach based on the two-way coupling arrangement, the restricted interaction area is defined via the size, structural configuration, and location of the coupling arrangement. The restricted interaction area corresponds to the portion of, or the area in, the touch sensitive area within which an external object shall lie in order to properly reflect the portion of the initially out-coupled light out so that it can be coupled back to the light guide assembly.

In implementations based on reflection of the out-coupled light from the external object, no true contact of the external object on the touch sensing device is necessary; it is sufficient to have the external object in sufficiently close proximity to the touch sensitive area device so that a sufficient portion of the initially out-coupled light is reflected back to the light guide assembly. Therefore, the term “touch” covers, in this context, also the presence of an external object in close proximity to the touch sensitive area.

In the above approach relying on two-way coupling arrangement(s), there are various alternatives to implement the actual coupling arrangements. In one embodiment, the coupling arrangement comprises at least one inclined reflective surface configured to couple light between the light guide assembly and the ambient by means of reflection from said surface. “Inclined” means here inclined with respect to the plane in which the light guide assembly is extended or, in the case of a curved, non-planar light guide assembly, the tangential plane of thereof. In other words, when light propagating in the light guide assembly meets a properly inclined, at least partly reflecting surface, it is reflected in a direction in which it escapes the light guide assembly. Respectively, a similar reflective surface can also reflect the light reflected from the external object in a direction in which it can again propagate within the light guide assembly e.g. via total internal reflections.

As one simple example of such reflecting inclined surfaces, a light guide stripe or a sub-stripe may be interrupted by a wedge-shaped prism or micro-prism, the one side of the prism serving for out-coupling and the other for in-coupling. The area outside the light guide assembly above the prism, from which area the initially out-coupled light can be reflected back to be in-coupled into the light guide stripe again, is the restricted interaction area.

Various forms of reflective surfaces and prism and arrays thereof can be used to implement the reflection-based coupling arrangements. In some designs, the same inclined surface(s) can serve for both out-coupling and in-coupling.

In addition to, or as alternatives for the reflective coupling elements, the coupling arrangement can also comprise at least one grating, for example a diffractive grating, configured to couple light between the light guide assembly and the ambient. Especially diffractive gratings provide effective and versatile means for controlling the out-coupling and in-coupling of light.

As an alternative to the approach based on a two-way coupling arrangement, the interaction arrangement can also comprise an exposed light guide surface section for interaction of the light propagating in the light guide assembly with the external object in touch with the exposed light guide surface section. By an exposed light guide surface section is meant here a section, i.e. an area of the light guide stripe or sub-stripe, which section is exposed to the free ambient space so that a true physical contact thereon by the external touching object is possible. In this approach, the interaction of the light with the external object is designed to take place only when the external object is in contact with the exposed light guide surface. In this approach, the exposed light guide surface section defines the restricted interaction area, in which area only a touch can change the light finally delivered out of the light guide assembly.

In one embodiment of the approach based,on the exposed light guide surface section, the restricted interaction area is defined by an opening in a cladding layer on a light guide. A cladding layer on a light guide provides physical protection for the light guide and also ensures proper optical operation thereof. For example, in a multi-mode light guide for light propagation via total internal reflections, the cladding layer material can be selected to ensure proper refractive index conditions at the light guide/cladding interface.

As stated above, at an exposed light guide surface section with no cladding layer thereon, an external object such as a finger can be brought on the touch sensitive area in direct contact with the light guide. This changes the conditions at the light guide/ambient interface and changes the conditions for total internal reflection. In practice, this typically makes part of the light power to leak out of the light guide resulting in losses in the light power finally delivered further out of the light guide assembly. In one embodiment, this phenomenon is utilized in that the light guide assembly is configured for detecting the touch of the external object on the exposed light guide surface section on the basis light intensity loss due to frustrated total internal reflection (FTIR).

According to a second aspect, the present invention is also focused on an optical touch sensing device having a touch sensitive area. The touch sensing device comprises a light guide assembly as defined above located in the touch sensitive area. By optical touch sensing device is meant here a complete, operable device which may comprise, in addition to the light guide assembly, also the light sources and detectors as well as appropriate electrical control means.

In one embodiment, the touch sensing device further comprises a transmitter system configured to transmit light signals to a plurality of light guide stripes, each of which is divided into at least two sub-stripes; and a receiver system configured to receive light signals delivered out of the light guide assembly. The transmitter and receiver systems can be implemented by using components, e.g. light sources such as LEDs or lasers and detectors, as well as signal processing elements as such known in the art.

In one preferred approach, the transmitter system is configured to modulate the signal transmitted to each light guide stripe of the plurality of the light guides stripes differently from the signals transmitted to the other light guide stripes of the plurality of the light guide stripes; and the receiver system is configured to identify the related first light guide stripe of each received light signal on the basis of said modulation. In other words, signal(s) send to each light guide stripe is/are individualized by the modulation so that based on the modulation, it can be resolved to which light guide stripe the finally received light signal delivered out of the light guide assembly was initially transmitted. This way, the location of the interaction area in the area of which the interaction took place can be determined. For example, if several sub-stripes divided from different light guide stripes are combined to form one common light guide stripe guiding light to one detector, the modulation allows identification of the light guide stripe to which the received light signal was initially transmitted.

In one embodiment, the light signals are transmitted to the light guide stripes simply at different times. The modulation can also be based on frequency modulation or different waveforms of the transmitted light signals. In a bit more sophisticated approach, the modulation is based on code division multiple access modulation (CDMA) of the transmitted light signals. Each of those modulation schemes can also be used in combination with one or more of the other modulation schemes.

As an alternative, or in addition to the actual modulation approaches above, in one embodiment, the transmitter system is configured to transmit the signal to each light guide stripe at a wavelength different from the wavelengths of the signals transmitted to the other light guide stripes; and the receiver system is configured to identify the related light guide stripe of each received light signal on the basis of the wavelength of the received signal.

According to a third aspect, the present invention is also focused on a touch screen comprising a display and an optical touch sensing device as defined above. The type and the details of the display as well as the touch sensing device and the integration thereof can be arranged according to the principles and practices known in the art. The display can be e.g. a liquid crystal display (LCD).

According to a fourth aspect, the present invention is further focused on a method for detecting a touch. According to the present invention, an optical touch sensing device as defined above is used in the method. The method comprises the steps of receiving light delivered further out of the light guide assembly of the touch sensing device; and detecting the presence of an external object on the touch sensitive area of the touch sensing device or in the vicinity thereof on the basis of changes in the thereby received light due to interaction of the light with the external object.

### BRIEF DESCRIPTION OF FIGURES

Various embodiments of the present invention are described in the following with reference to the accompanying schematic drawings (presented not in scale), wherein

FIG. 1 illustrates a configuration of a touch sensing device;

FIGS. 2a and 2b illustrate details of a light guide assembly;

FIGS. 3a to 3c illustrate coupling elements and coupling arrangements for use in a interaction arrangement of a light guide assembly; and

FIGS. 4a to 4c, 5a to 5d, 6, and 7a to 7c illustrate interaction arrangements based on exposed light guide surface sections for use in a light guide assembly.

In the drawings, the corresponding elements of different embodiments are marked with the same reference numbers. The propagation of light in the presented structures is generally marked with arrows.

### DETAILED DESCRIPTION

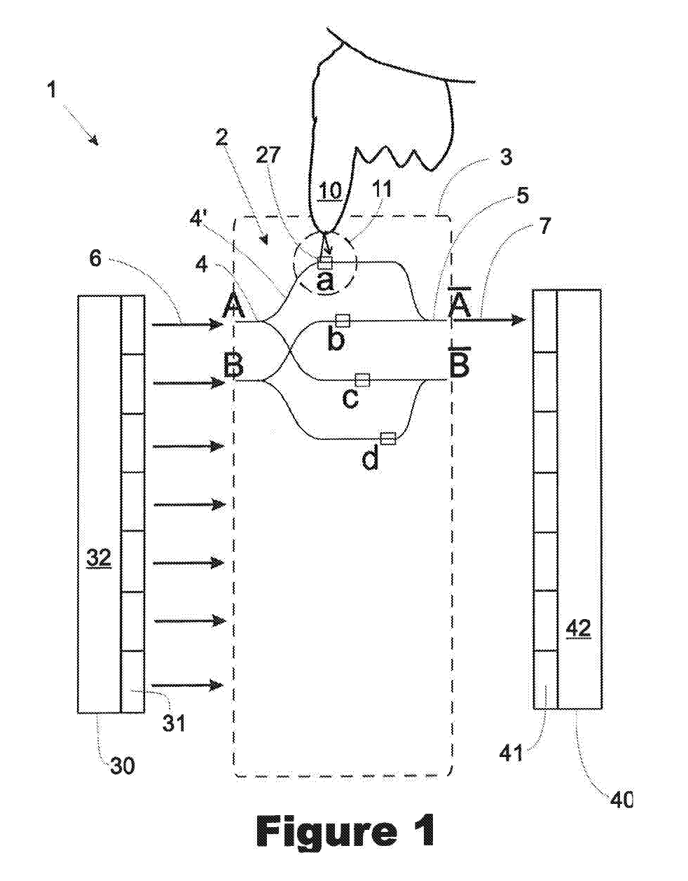

FIG. 1 illustrates a part of an optical touch sensing device 1 comprising a light guide assembly 2 arranged in a touch sensitive area 3 of the touch sensing device.

The light guide assembly 2 of FIG. 1 comprises a grid of light guides 4, 4′, 5. The light guides are formed as narrow stripes, and they are designed and formed for receiving illumination light 6 in the form of light signals, and for guiding the received light in the light guide assembly and further delivering light 7 out of the light guide assembly. Preferably, the illumination light lies in the infrared portion of the spectrum so that interference with the visible wavelengths emitted by the display of a touch screen or present in the ambient is minimized.

The operation principle of the optical touch sensing device 1 is based on detecting the effects of interaction between an external object, e.g. a finger 10 of a user of the touch sensing device, and the light transmitted into the light guide stripe.

The touch sensing device 1 of FIG. 1 comprises further a transmitter system 30 and a receiver system 40 for transmitting light signals 6 to the light guide stripes 4 and for receiving light signals 7 delivered out of the light guide assembly, respectively. The transmitter system 30 comprises a plurality of light sources 31, e.g. light emitting diodes LEDs, driven and controlled by a signal processing and control unit 32. Respectively, the light receiving unit 40 comprises a plurality of light detectors 41 coupled to a detecting unit 42 having appropriate electronics for receiving and processing the received signals. Naturally, the transmitter and receiver systems may also comprise any appropriate further electronic, optical, or mechanical means required to implement the light signal transmitting and receiving functions.

The grid of light guides comprise light guide stripes 4, 5 for receiving light signals 6 from the light sources of the transmitter system and for directing the light 7 finally delivered out of the light guide assembly to the detectors of the receiver system, respectively. In FIG. 1, light guide stripes for two light sources and two light detectors only are shown. Naturally, there may be source-to-detector lines for receiving light from every light source and for guiding light to every detector element. Both of the illustrated light guide stripes from the two light sources are divided into two sub-stripes 4′, one for each of the two detectors. On the other hand, at the end of the receiver system, the sub-stripes from two different sources are combined to form common receiving end light guide stripes 5.

For the sake of clarity of the drawing, FIG. 1 shows each light guide stripe as divided into two sub-stripes only. Naturally, the basic idea of light guide stripes from the light sources, which are divided into sub-stripes for the detectors, can be expanded so that light from each source, e.g. a laser, is divided into three detection points, four detection points and so on. On the other hand, it is to be noted that the number and positioning of the transmitter and receiver systems shown in FIG. 1 is just one simple example, not limiting the embodiments of the invention to that example.

In the example of FIG. 1, the two light guide stripes 4 divided into the sub-stripes 4′, which are then again combined into the common receiving end light guide stripes 5, form four “source-to-detector lines” (lines AĀ, AB̅, BĀ, and BB̅). Each of those lines has one interaction arrangement 27 (marked with detection points “a”, “b”, “c”, and “d” in the drawing) along the sub-stripe at issue, the interaction arrangement defining a restricted area of interaction 11. In the example of FIG. 1, the interaction means reflection of the light, initially coupled out of the light guide assembly, so that at least part of the initially out-coupled light is coupled back to the light guide assembly, into the same sub-stripe from which it was coupled out. This is illustrated in FIG. 1 by an arrow indicating light which is coupled out of the interaction arrangement at detection point “a”, and coupled back to the same sub-stripe after reflection from a finger 10 of the user of the touch sensing device.

The transmitter system is configured to individualize the signals transmitted to the light guide stripes so that when a light signal at least partially coupled back to the light guide assembly is delivered out of a common receiver end light guide stripe, the light guide stripe from which the light signal was initially coupled out can be determined by the receiver system 40 on the basis of said individualization. Consequently, also the location of the restricted area of interaction 11, within which the reflection of light from the external object 10 caused the coupling of the initially out-coupled light signal back to the light guide assembly, can be determined. This way, the location of touch can be found out.

The individualization can be based on simple time differentiation. In other words, the transmitter system may be configured to transmit the signals 6 to the different light guide stripes 4 at different times. For example, all those four detection points marked in FIG. 1 can be read by two consecutive light pulses. First the source “A” is pulsed, and detection points “a” and “c” in the sub-stripes supplied by this light source, e.g. a laser, are read by detectors “A” and “B”. Then, the source “B” is pulsed and detection points “b” and “d” are read. The signals received by detectors A and B can be used for detecting a touch and determining the location thereof. If each light guide stripe from the light sources is divided into more than two sub-stripes for more than two detectors, the same idea applies. For example, nine detection points can be read with three laser pulses, and so on.

Alternatively, or in addition to the time differentiation, the individualization of the transmitted signals can be based on various modulation principles, wherein the signal transmitted to each light guide stripe 4 is modulated differently from the signals transmitted to the other light guide stripes. For example, the modulation can be based on frequency modulation of the transmitted light signals or on different waveforms of the transmitted signals. Also code division multiple access modulation (CDMA) can be used. The signals can also be transmitted to the different light guide stripes at different wavelengths, in which case the receiver system naturally has to be capable of determining the wavelength of the received signal 7.

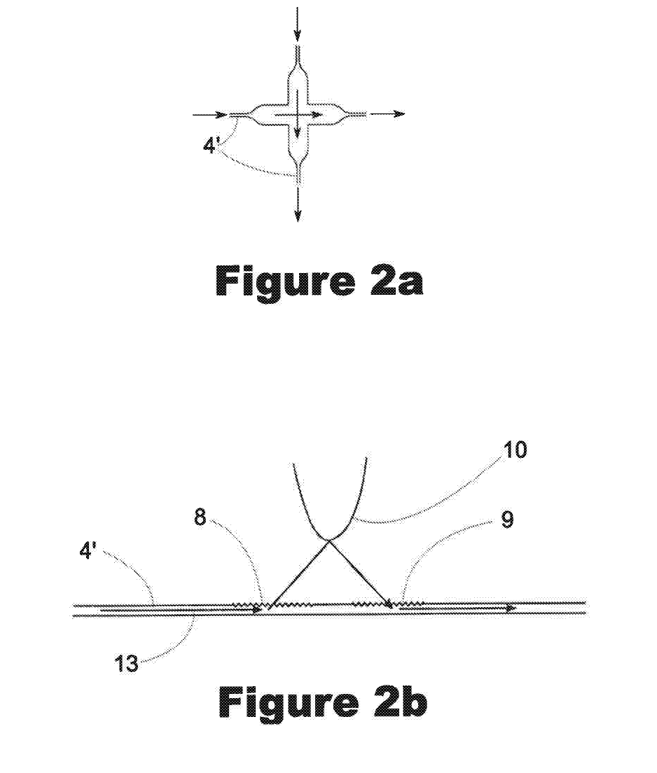

One issue requiring appropriate consideration in the embodiment illustrated in FIG. 1 is that there are crossing light guides and each crossing point potentially increases the optical losses. One solution to solve this problem is that the waveguides are made into different layers. This is an operationally straightforward solution. However, from manufacturing point of view, that naturally increases the complexity of the manufacturing process. The crossing losses may be reduced by expanding the light guide stripe width at the crossing area, as shown in FIG. 2a. Such broadenings are believed to decrease the crossing losses in particular in single-mode light guides.

By means of the light guide arrangement illustrated in FIG. 1, the spatial resolution of a touch sensitive area of a touch sensing device can be improved or, from another point of view, the number of required light sources and detectors can be reduced in comparison to an approach being based on one single separate light guide stripe between each source-detector pair.

The light guide stripes 4, 4′, 5 of FIG. 1, as well as the light guide stripes in the examples of the other Figures, too can be designed and manufactured according to the principles and practices known in the art. For example, the light guide stripes can have a circular, elliptical, or rectangular cross-section and they can be made of some plastic light guide materials, e.g. PMMA (Polymethyl methacrylate) or PET (Poly-ethylene terephthalate). On the other hand, silicon dioxide SiO₂, titanium dioxide TiO₂, and silicon nitride Si₃O₄ are examples or harder materials as an alternative to plastics. The dimensions of the light guide stripes can be adjusted e.g. according to the desired resolution performance of the touch sensing device. The light guide stripes can be configured for single mode or multi-mode light wave propagation. For example, in single-mode wave guides, the width of a stripe can be about 10 μm or less. In multi-mode light guides, the typical width is 50 μm or higher, it can lie also in the millimeter scale. In particular in the embodiments with two-way coupling arrangements, the width of the in-coupling element should be sufficiently large to ensure sufficient in-coupling of light, which can affect the requirements for width of the light guide stripe.

Plastic light guide stripes can be manufactured e.g. by using nanoimprint lithography NIL. For the harder materials, one possibility for manufacturing is formed by various thin film and photolitographic processes.

In the example illustrated in FIG. 1, the interaction arrangements 27 comprise out-coupling elements for coupling part of the illumination light out of the sub-stripes, and in-coupling elements for coupling the part of this out-coupled light, as reflected from an external object, such as the fingertip 10 illustrated in the drawing of FIG. 1, back to the light guide assembly 2. Thus, each pair of out-coupling and in-coupling elements can be considered as an interaction arrangement defining a restricted area of interaction 11, i.e. an area on the touch sensing region within which an external object can cause the light propagating via the light guide assembly to interact with the external object. In other words, an external object lying too far from a pair of an out-coupling and an in-coupling grating cannot cause such interaction. Such interaction, in turn, causes a detectable change in the light 7 delivered further out of the light guide assembly.

From the operational point of view, a touch of an external object on, or the presence of such in the proximity of the touch sensitive area 3, causes an increase in the light power delivered out of the common receiving end light guide stripe corresponding to the location of the external object.

The coupling elements may comprise diffractive optical gratings. Diffractive optics provides an efficient and versatile way to design and manufacture coupling elements with various coupling characteristics. Diffractive gratings may be designed and manufactured according to the principles known in the art, so no detailed explanation thereof is given here. As an example, diffractive gratings with a blazed grating profile or a binary slanted grating profile may be used. FIG. 2b illustrates a principle of a two-way coupling arrangement based on an out-coupling diffraction grating 8 and an in-coupling diffraction grating 9, both arranged at an upper surface of a sub-stripe 4′ forming a part of one source-to-detector line. The light 13 propagating in the sub-stripe is coupled at least partially out of the sub-stripe at the out-coupling grating 8. The out-coupled light is reflected at least partially from an external object 10, e.g. a finger, and coupled back to the sub-stripe via the in-coupling grating 9.

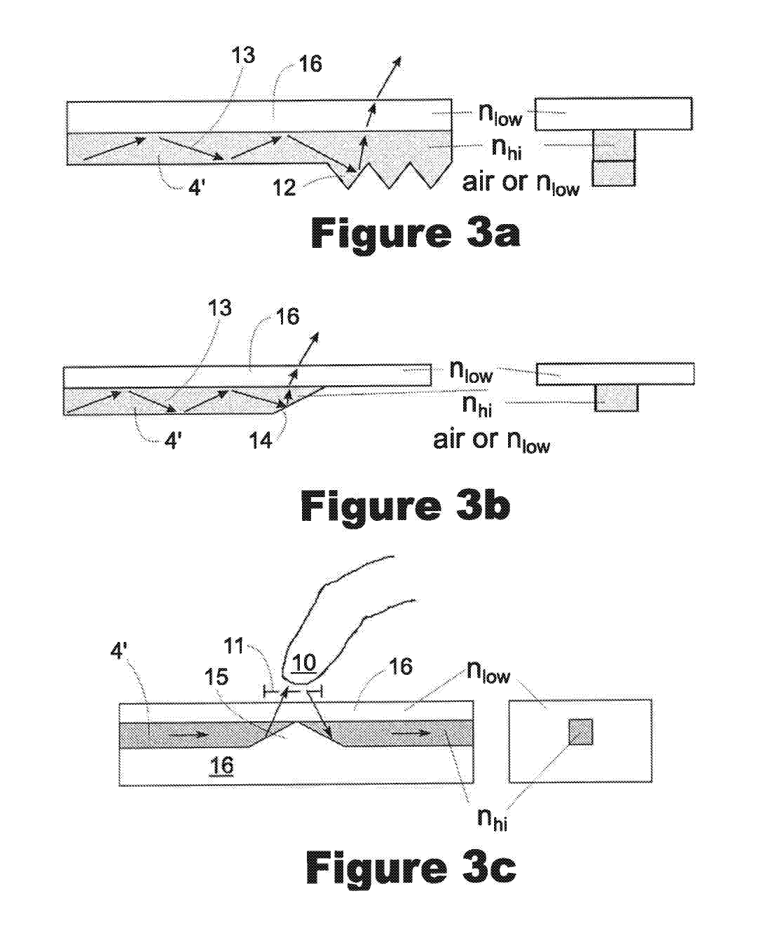

As an alternative to diffractive gratings, the coupling elements may also be based on more simple reflective surfaces arranged in the light guide assembly. FIG. 3a shows schematically, as a longitudinal section and a cross section, an array of microprisms 12 on a surface of a sub-stripe 4′, configured to couple a part of the light 13 propagating in the sub-stripe out of it. FIG. 3b shows as another example, wherein a sub-stripe simply ends with an inclined facet 14 which reflects part of the light 13 propagating in the sub-stripe and incident on the inclined facet out of the sub-stripe. Similar structures can be used also as in-coupling elements configured to couple a part of the out-coupled light, after reflection from e.g. a fingertip, back to the light guide assembly. In both of the examples of FIGS. 3a and 3b, the light guide structure comprises a low refractive index (“n_{low}”) cladding layer 16 on the actual higher refractive index (“nₕᵢ”) sub-stripe for protecting the latter and ensuring proper conditions for total internal reflections at the surface thereof.

In another example shown in FIG. 3c, the low refractive index cladding 16 of a light guide comprises a simple triangular or wedge-formed protrusion 15 locally cutting off the core of the light guide, i.e. the actual sub-stripe 4′. A touch close to the protrusion reflects part of the light coupled out of the sub-stripe via one side of the protrusion back to the light guide assembly, into the same sub-stripe, via the other side of the protrusion.

In the examples of FIGS. 1 to 3, the operation of the touch sensing device is thus based on reflection of part of the initially out-coupled light back to the light guide assembly. This kind of interaction between the light and the external object does not necessitate a true physical contact between the touching external object and the touch sensing device. Sufficient reflection may be achievable also by an external object brought into sufficiently close proximity of the touch sensing device. The size and the structural and material details of the coupling arrangement define a restricted interaction area 11 within which an external object 10, sufficiently close to the light guide, can cause detectable interaction between the light and the external object.

Instead of a two-way coupling arrangement, an interaction arrangement 27 in a light guide assembly as that of FIG. 1 may also be based on other principles. Examples are described in the following.

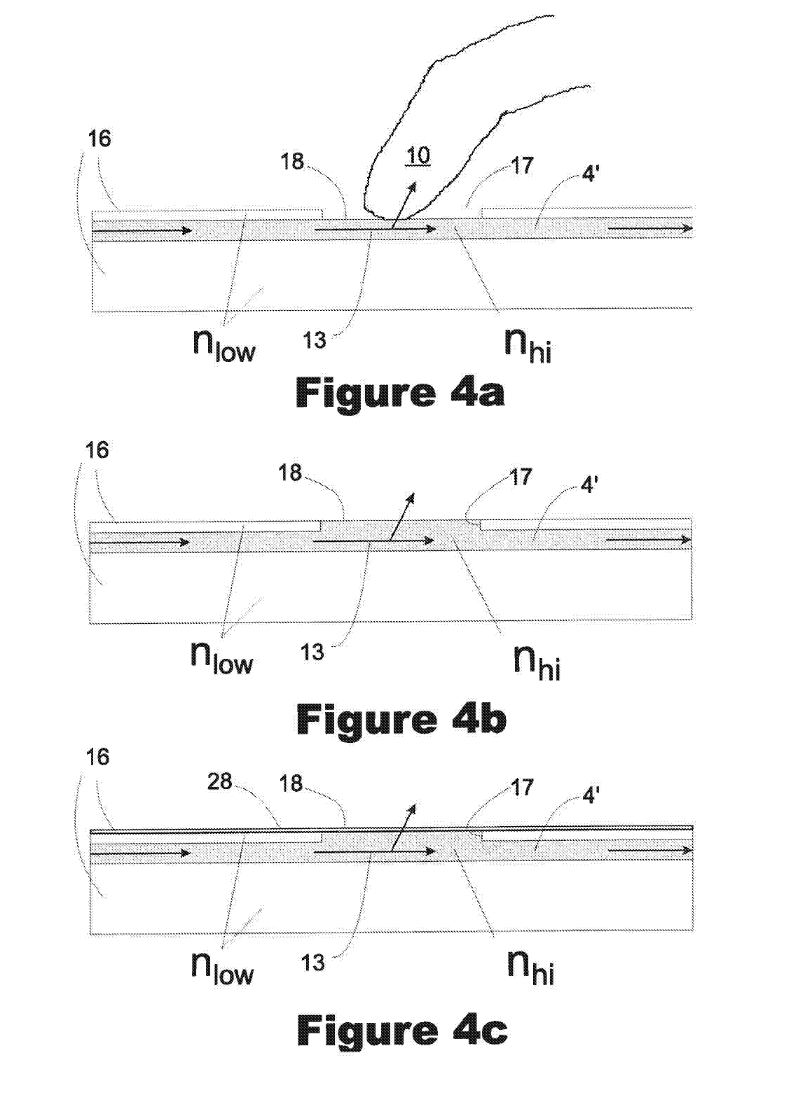

FIG. 4a illustrates schematically one example, where the interaction of the light 13 propagating in the light guide assembly with the external object 10, e.g. a finger, is based on direct physical contact of the external object with the light guide assembly. FIG. 4a shows a high refractive index sub-stripe 4′ embedded within a cladding 16 with a lower refractive index. An opening 17 is formed in the cladding layer on the user side of the touch sensing device. This opening defines an exposed light guide section 18, i.e. a section of the light guide surface exposed to the free ambient space. This exposed light guide surface section defines a restricted interaction area for possible interaction between an external object and the light propagating in the sub-stripe. In this example, the interaction mechanism is frustrated total internal reflection (FITR). In other words, a touch of an external object on the exposed light guide surface section changes the conditions for the total internal reflections at the light guide surface, and thereby causes part of the light power to leak out of the light guide. The touch is thus detected via a decrease in the light power delivered further out of this light guide stripe.

In FIGS. 4b and 4c, modifications of the structure of FIG. 4a are shown. In the light guide structure of FIG. 4b, the opening 17 in the cladding layer 16 is filled with the high refractive index material of the actual light guide so that the exposed light guide surface section lies substantially in the same plane as the free surface of the cladding layer 16. In the modification of FIG. 4c, there is an additional thin protective layer 28 on a structure similar to that of FIG. 4b. Such protective layer provides protection of the light guide surface against contamination and damages, such as scratches. The protective layer may be formed e.g. of some glass material.

From optical operation point of view, in the area of the opening 17, the protective layer 28 forms a part of the light guide and the exposed surface section 18 thereof. Preferably, the refractive index of the protective layer is similar or close to that of the actual light guide. It may be also a bit lower, in which case, with sufficiently high incident angle, total internal reflection takes place at the interface between the actual sub-stripe 4′ and the protective layer 28. Then, the thickness of the protective layer should be so low that the evanescent field of the light extends over the protective layer to the free surface thereof so that an interaction of the light with a touching object is possible.

In the case of a refractive index of the protective layer 28 higher than that of the actual light guide, light is refracted at the actual light guide/protective layer interface towards the surface normal. However, at the protective layer/free ambient space interface, total internal reflection occurs for those incident angles in the actual light guide for which it would occur at a light guide/free ambient space interface also, i.e. in the case of without any protective layer. Thus, a protective layer with a higher refractive index than that of the actual light guide material does not affect the conditions for propagation of light within the light guide via total internal reflections. However, also in this case the thickness of the protective layer should be limited in order to prevent a light guide formation between the cladding layer 16 and the free air.

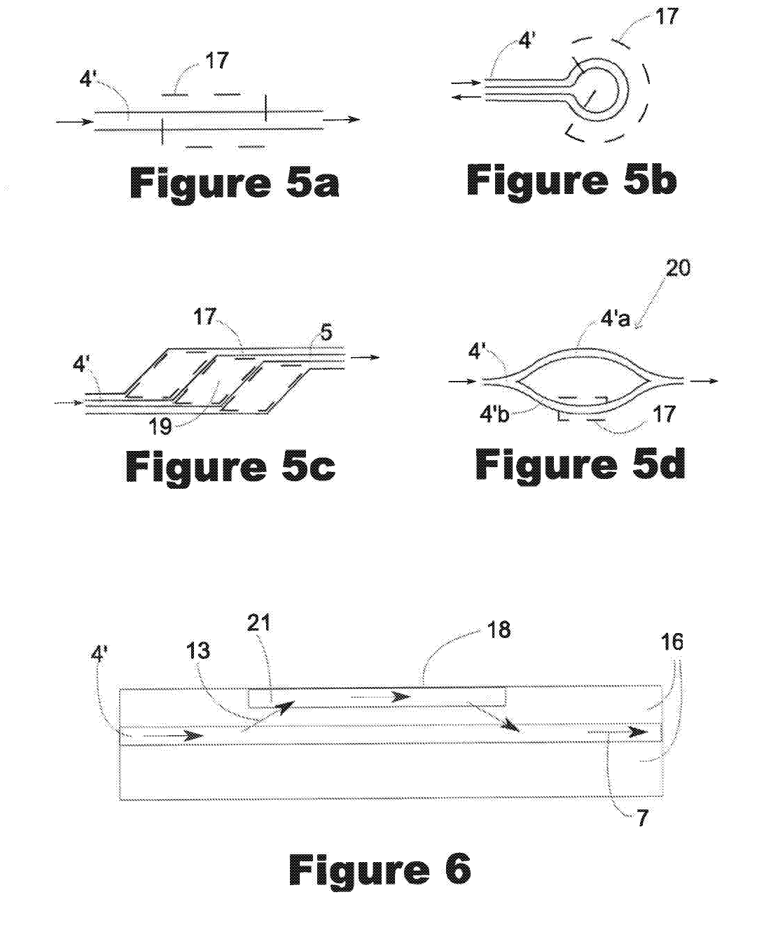

Said principle of forming a restricted interaction area by means of an opening in the cladding layer can be utilized in many ways to implement a light guide assembly for a touch sensing device. FIG. 5a shows, as a schematic top view, a simple example with a straight section of a sub-stripe 4′. An opening 17 in the cladding layer is marked with a dashed line. As an example, with an array of that kind of sub-stripes, each having an opening at different location in the longitudinal direction of the stripes, a large touch sensitive area can be covered.

FIG. 5b shows a loop-shaped light guide, where the receiving and delivering ends of the light guide lie adjacent to each other. An opening 17 in the cladding layer is formed over the loop area. This configuration can be used in a configuration where the transmitter and the receiver systems of the touch sensing device lie on the same side of the touch sensitive area 3. A plurality of this kind of loop-formed sub-stripes 4′ with cladding openings at the loops can be used to form a plurality of touch sensitive pixels.

In FIG. 5c, an array of parallelogram-shaped sub-stripes 19, each connected to an input and output sub-stripe sections 4′, is shown. Openings 17 are arranged in the cladding layer to expose the parallelogram-shaped sections. This kind of array can be used to generate a two-dimensional matrix of touch sensitive pixels, each pixel being formed by one parallelogram-shaped section of a light guide. Naturally, the number of such pixel is not limited to three according to the example of FIG. 5c. It is also important to note that parallelogram is disclosed here as one example only; the principle of forming a multi-pixel array is applicable to many other pixel shapes also.

In FIG. 5d, a Mach-Zehnder type interferometer 20 is shown. The interferometer has a sub-stripe 4′ which is divided into two arms 4′a, 4′b and then combined into a single sub-stripe again. The two arms are dimensioned so that the light waves propagating through the two arms experience phase shifts causing either constructive (the same phase) or destructive (half-wave difference in the phase) interference where the two arms are combined. There is an opening 17 in the cladding layer on one of the arms. A touch on this exposed section of the light guide surface causes makes the light wave in the associated arm to interact with the touching object, thereby affecting the phase the light wave experiences. This changes the conditions for interference, and thus the output light intensity. In the case of initially constructive interference, a touch destroys the conditions for the interference, resulting in a decrease in the light intensity delivered finally out of the sub-stripe. In the case of initially destructive interference, the effect may be the opposite, i.e. an increase in the light intensity.

FIG. 6 illustrates an alternative to an opening in a cladding layer to form an exposed light guide surface section 18 defining a restricted interaction area. The light guide structure of FIG. 6 comprises, in addition to a light guide embedded within a cladding 16, an additional light guide section 21 at the surface of the light guide structure. This additional light guide section and the actual light guide of the sub-stripe 4′ are configured so as to form an optical directional coupler. An optical directional coupler is a well-known component in integrated optics, wherein light waves are coupled from one waveguide to an adjacent waveguide over a distance substantively without losses. In this embodiment, the exposed additional light guide section 21 thus defines a restricted interaction area, wherein a touch of an external object causes part of the light power, coupled to the additional light guide section, to be coupled out of the light guide structure. This is again seen as losses in the light 7 finally delivered out of the light guide assembly.

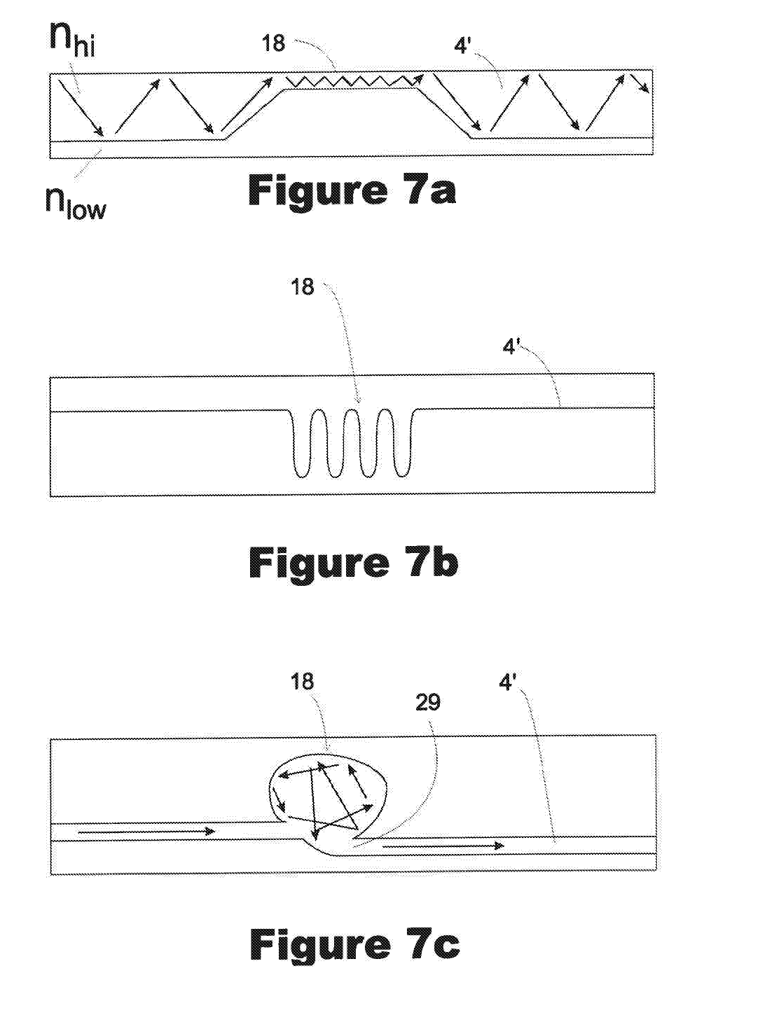

In FIGS. 7a to 7c, yet further alternatives to form an exposed light guide surface section 18 are presented. The principle in these embodiments is to form a section of increased sensitivity along a predetermined section of a “source-to-detector” line formed by a sub-stripe 4′.

In the example of FIG. 7a, the thickness of the light guide of the sub-stripe 4′ is thinned locally by having its lower surface brought closer to the upper, i.e. the free surface. Due to the lower thickness, the light experiences more total internal reflections per distance along the longitudinal direction of the light guide stripe. In other words, in the thinner section, the individual light beams are more often in contact with the top of the stripe, allowing for greater losses caused by interaction. Therefore, within a specific contact area of a touch, there are more reflection points than in the thicker sections of the light guide stripe. This causes a bigger portion of the light power to be coupled or leaked out of the light guide. In the case of single-mode light guides, this same principle of local lowering of the waveguide thickness increases the light field energy portion outside the light guide and thus subject to interaction with a touching object. Thus, the sensitivity to touches is increased.

In some applications, it may be possible to increase the sensitivity of light to touches by decreasing the lateral width of the light guide of the sub-stripe also.

In FIG. 7b, there is another variation of the same principle of increasing the sensitivity, viewed from above. In this case the sub-stripe is bent to form a meandering section to achieve a greater contact surface area per length at a specific section of the light guide stripe. Similarly to the embodiments of FIGS. 7a and 7c, this approach can be used either with a low refractive index cladding layer and an opening therein in the area of the increased sensitivity section or without such cladding layer. In the latter case, the extra sensitivity in the exposed light guide surface section 18 can be sufficient to cause the desired increase of sensitivity in the desired location so as to form a restricted interaction area. Naturally, there can also be a protective layer on the light guide in the embodiments of FIGS. 7a to 7c.

In FIG. 7c, there is yet another variation of the same structure, viewed from above. In this case there is a rounded section in the sub-stripe 4′ forming an exposed light guide surface section 18, in turn defining a restricted interaction area. The purpose of this structure is to make individual light beams perform several rounds inside the rounded area, before escaping via opening 29. Again, the principle is to increase the possibility for interaction of the light with an external touching object, and thereby increase the sensitivity of the light to FTIR losses.

To summarize, the embodiment illustrated in FIG. 1 is suitable for configurations based on any types of interaction arrangements formed along single sub-stripes. By this is meant, first, interaction arrangements with two-way coupling arrangements where light, initially coupled out of a sub-stripe, is coupled after reflection from an external object back to the same sub-stripe, or at least to a light guide stripe on the same “source-detector line”. On the other hand, the interaction arrangements can also be based on exposed light guide surface sections. Examples of both alternatives are described above. In both cases, the interaction arrangement defines a restricted interaction area located at a predetermined point along a sub-stripe, in which area a touch can cause interaction between the light propagating in the light guide and the external touching object, e.g. a finger of a user of the touch sensing device. In FIG. 1, the restricted interaction areas are marked by rectangles along the sub-stripes.

It is important to note that the above examples are for illustrative purposes only, without limiting the scope of the invention. The embodiments of the present invention may freely vary within the scope of the claims.

1. A light guide assembly for use in a touch sensitive area of an optical touch sensing device for touch screens, the light guide assembly being configured to receive light, to allow the light thereby received to propagate in the light guide assembly, and to deliver the light thereby propagated in the light guide assembly further out of the light guide assembly, the light guide assembly comprising a plurality of light guide stripes for controlling the light propagation in the light guide assembly, and an interaction arrangement configured to define at least one restricted interaction area within the touch sensitive area for interaction between the light and the external object; the optical touch sensing device being configured to detect the presence of an external object on the basis of changes in the light delivered further out of the light guide assembly due to interaction of the light with the external object, wherein the light guide assembly comprises source-to-detector lines for at least two sources and detectors, the source-to-detector lines being formed by light guide stripes, each of which is divided into at least two sub-stripes, one for each detector, each source-to-detector line having one interaction arrangement defining a restricted interaction area, wherein at the detector end of the source-to-detector lines, the sub-stripes originating from several different light guide stripes from different sources are joined to form a common single light guide stripe for guiding light signals from different sources to one single detector.

2. A light guide assembly as defined in claim 1, wherein the at least one interaction arrangement comprises a two-way coupling arrangement configured to couple light out of the light guide assembly, out of one sub-stripe, and to couple a portion of the thereby out-coupled light, after reflection from the external object, back to the light guide assembly into the same sub-stripe for detecting the presence of the external object on the basis of said reflection.

3. A light guide assembly as defined in claim 2, wherein the coupling arrangement comprises at least one inclined reflective surface configured to couple light between the light guide assembly and the ambient by means of reflection.

4. A light guide assembly as defined in claim 2, wherein the coupling arrangement comprises at least one grating, configured to couple light between the light guide assembly and the ambient.

5. A light guide assembly as defined in claim 1, wherein the interaction arrangement comprises an exposed light guide surface section for interaction of the light propagating in the light guide assembly with the external object in touch with the exposed light guide surface section.

6. A light guide assembly as defined in claim 5, wherein the restricted interaction area is defined by an opening in a cladding layer on a light guide.

7. A light guide assembly as defined in claim 5, wherein the light guide assembly is configured for detecting the touch of the external object on the exposed light guide surface section on the basis light intensity loss due to frustrated total internal reflection.

8. An optical touch sensing device having a touch sensitive area, wherein the touch sensing device comprises a light guide assembly as defined in claim 1 located in the touch sensitive area.

9. An optical touch sensing device as defined in claim 8, further comprising
a transmitter system configured to transmit light signals to a plurality of light guide stripes; and
a receiver system configured to receive light signals delivered out of the light guide assembly.

10. An optical touch sensing device as defined in claim 9, wherein
the transmitter system is configured to modulate the light signal transmitted to each light guide stripe differently from the signals transmitted to the other light guide stripes; and
the receiver system is configured to identify the related light guide stripe of each received light signal on the basis of said modulation.

11. An optical touch sensing device as defined in claim 10, wherein the modulation is based on transmitting the light signals to the light guide stripes at different times.

12. An optical touch sensing device as defined in claim 10, wherein the modulation is based on frequency modulation of the transmitted light signals.

13. An optical touch sensing device as defined in claim 10, wherein the modulation is based on different waveforms of the transmitted light signals.

14. An optical touch sensing device as defined in claim 10, wherein the modulation is based on code division multiple access modulation of the transmitted light signals.

15. An optical touch sensing device as defined in claim 9, wherein
the transmitter system is configured to transmit the light signal to each light guide stripe at a wavelength different from the wavelengths of the signals transmitted to the other light guide stripes; and
the receiver system is configured to identify the related light guide stripe of each received light signal on the basis of the wavelength of the received signal.

16. A touch screen comprising a display and an optical touch sensing device as defined in claim 8.

17. A method for detecting a touch using an optical touch sensing device as defined in claim 8, the method comprising the steps of
receiving light delivered further out of the light guide assembly of the touch sensing device, and
detecting the presence of an external object on the basis of changes in the thereby received light due to interaction of the light with the external object.

18. A light guide assembly as defined in claim 4, wherein the coupling arrangement comprises at least one diffractive grating.
